(19) United States
(12) Patent Application Publication
(10) Pub. No.: US 2023/0111707 A1
(43) Pub. Date: Apr. 13, 2023

(54) METHODS AND APPARATUS FOR HIGH THROUGHPUT MICRODROPLET MANIPULATION

(71) Applicant: LIGHTCAST DISCOVERY LTD, Cambridge, Cambridgeshire (GB)

(72) Inventors: James BUSH, Cambridge, Cambridgeshire (GB); Jasmin Kaur Chana CONTERIO, Cambridge, Cambridgeshire (GB); Pedro CUNHA, Cambridge, Cambridgeshire (GB); William Michael DEACON, Cambridge, Cambridgeshire (GB); Cameron FRAYLING, Cambridge, Cambridgeshire (GB); Thomas Henry ISAAC, Cambridge, Cambridgeshire (GB); Ibrahim Saygin TOPKAYA, Cambridge, Cambridgeshire (GB)

(73) Assignee: LIGHTCAST DISCOVERY LTD, Cambridge, Cambridgeshire (GB)

(21) Appl. No.: 17/794,758

(22) PCT Filed: Jan. 22, 2021
(86) PCT No.: PCT/GB2021/050148

§ 371 Date: Jul. 22, 2022

(30) Foreign Application Priority Data
Jan. 24, 2020 (GB) 2001051.8

(51) Int. Cl. B01L 3/00

(52) U.S. Cl. CPC B01L 3/502792; B01L 2200/0647; B01L 2300/027; B01L 2300/0645; B01L 2300/0654; B01L 2400/0427

(57) ABSTRACT

The present invention provides methods and apparatus for manipulating and interrogating the contents of large numbers of microdroplets in parallel on a surface of a microfluidic chip. According to one aspect of the invention a method is provided for manipulating and inspecting microdroplets on a microfluidic chip by optically- mediated electrowetting (oEWOD), the method comprising forming, using a first optical assembly, a plurality of oEWOD traps on a surface of the chip and forming, using a second optical assembly, a second array of oEWOD traps on the surface of the chip, and making an adjustment to the first optical assembly whilst one or more of the microdroplets are held in place by second array of oEWOD traps. Apparatus comprising a microfluidic chip and first and second optical assemblies is also provided.

### FIELD

The present disclosure relates to methods and apparatus for manipulation of microdroplets and, in particular, to the application of optically mediated electrowetting-on-device / optical electrowetting on dielectric (oEWOD) techniques to manipulate and interrogate the contents of large numbers of microdroplets in parallel on a surface of a microfluidic chip.

### BACKGROUND

Electrowetting-on-dielectric (EWOD) is a well-known effect in which an electric field applied between a liquid and a substrate makes the liquid more wetting on the surface than the natural state. The effect of electrowetting can be used to manipulate (e.g., move, divide, or change shape of) fluids by applying a series of spatially varying electrical fields on a substrate to increase the surface wettability following the spatial variations in a sequence. Droplets manipulated in electrowetting-based devices are typically sandwiched between two parallel plates and actuated by digital electrodes. The size of pixelated electrodes limits the minimum droplet size that can be manipulated as well as the rate and scale at which droplets can be processed in parallel.

In our published application WO 2018/234445, the entirety of which is incorporated by reference herein, we have described a device for manipulating microdroplets which uses optoelectrowetting to provide the motive force. In this optically mediated electrowetting (oEWOD) device, the microdroplets are translocated through a microfluidic space defined by containing walls; for example a pair of parallel plates having the microfluidic space sandwiched therebetween. At least one of the containing walls includes what are hereinafter referred to as ‘virtual’ electrowetting electrodes locations which are generated by selectively illuminating an area of a semiconductor layer buried within. By selective illumination of the layer with light from a separate light source, controlled by an optical assembly, a virtual pathway of virtual electrowetting electrode locations can be generated transiently along which the microdroplets can be caused to move. Thus conductive cells are dispensed with and permanent droplet-receiving locations are abandoned in favour of a homogeneous dielectric surface on which the droplet-receiving locations are generated ephemerally by selective and varying illumination of points on the photoconductive layer using, for example, a pixelated light source. This enables highly localised electrowetting fields capable of moving the microdroplets on the surface by induced capillary-type forces to be established anywhere on the dielectric layer; optionally in association with any directional microfluidic flow of the carrier medium in which the microdroplets are dispersed; for example by emulsification.

Another disclosure of oEWOD is the single sided open configuration platform of Park, Sung-Yong, Michael A. Teitell, and Eric PY Chiou, “Single-sided continuous optoelectrowetting (SCOEW) for droplet manipulation with light patterns.” Lab on a Chip 10.13 (2010): 1655-1661.

Although these existing platforms allow for fine-grained microdroplet motion control, due to the use of microscope optics to address the sample there is a practical limit to the number of droplets that can be processed in parallel within a single field of view (a few thousand). However for some applications, in particular for large scale screening applications such as those often necessary in the pharmaceutical industry, it is required to handle numbers of droplets of the order 10⁶ or more.

For example, in the fields of cell line development and antibody development, there is a need to allow for initial screening of a large number of biological agents (up to millions) to enable the reduction of the number of agents down to sensible numbers (thousands). To achieve an efficient workflow this initial screen needs to take place across a large number of biological agents in a multiplexed fashion.

### SUMMARY OF INVENTION

The present disclosure provides methods and associated apparatus wherein the flexibility of oEWOD microfluidic chips is combined with two individually controllable optical assemblies, both of which are capable of generating fixed but switchable arrays of light spots on the surface of the oEWOD chip. Such a configuration enables high throughput and flexible loading and processing of microdroplets, thus solving the need for multiplexed handling in screening applications.

According to the present invention there is provided a method of inspecting and/or selecting microdroplets on a microfluidic chip by optically-mediated electrowetting (oEWOD), the method comprising: temporarily forming a plurality of oEWOD traps on a surface of the chip to cause a plurality of microdroplets on the surface of the chip to form an array of microdroplets; holding the entire array of microdroplets whilst inspecting at least one subset of the array.

Typical implementations of the method of the present invention are cyclic and hierarchical. At a minimum, the method must either involve an inspection of microdroplets or a selection of a subset of the microdroplets. A selection without inspection can be appropriate where there is uniformity across a subset of the microdroplets and therefore that subset can be selected automatically, without inspection. An inspection without selection is appropriate to monitor the status of a plurality of the microdroplets. A typical mode of operation would be to inspect the microdroplets and then to select a subset of the inspected microdroplets on the basis of the information gleaned from the inspection step. Once selected, the subset of microdroplets can be held and/or manipulated. The cycle of inspection and selection can then be repeated and subsequent holding and/or manipulation steps can follow on the basis of the data gleaned on inspection.

The deployment of oEWOD traps to create a transient array provides a considerable advantage over related technologies which rely on physical structures for containment of microdroplets. The transient structure introduces considerable flexibility to create different structures and to modify structures in real time.

The term oEWOD trap, used herein, can also be referred to as a sprite. It is a light projection onto the surface and it does not encompass a pen or well permanently located on the surface. The sprites can form an array, move a proportion of the array and recreate a different array on a subsequent occasion. The surface onto which the sprites are projected is therefore effectively a blank canvas, unconstrained by permanent, physical geometries that locate microdroplets.

The ability to hold the entire array of microdroplets whilst inspecting a subset of the array allows sequential, detailed inspection of the array down to the microdroplet by microdroplet level without losing contact with the whole array. By inspecting a subset of the array an optical assembly with a different field of view can be deployed without losing the microdroplets that are not within the inspection field of view.

The step of holding the entire array of microdroplets may comprise holding the entire array in a stationary configuration. Alternatively, the step of holding may comprise holding some or all of the array in motion. Some or all of the array may be held whilst executing a progression across the surface of the chip. This progression may be at a substantially constant speed or it may include a deceleration as some or all of the microdroplets reach a stationary configuration, in which they are subsequently held. This step may include the capture of droplets that are not attached or locked on to sprites or oEWOD traps.

The step of holding the entire array of microdroplets may be facilitated by the substeps of: temporarily forming a second array of oEWOD traps on the surface of the chip; and aligning one or more of the oEWOD traps of the second array with the oEWOD traps of the first array.

The alignment of the first and second arrays of oEWOD traps enables a hand off between first and second optical assemblies that form the respective arrays enabling each optical assembly to inspect or manipulate a subset of the array of microdroplets whilst the entire array is being held in place. In some embodiments, only the second optical assembly can hold the entire array, whilst both optical assemblies can inspect and hold a subset of the array.

Because either of the two assemblies can hold, inspect and manipulate at least a subset of the array, the responsibility for holding the microdroplets can be handed off between the two assemblies in order to optimise the optical performance of the optical assembly undertaking the detailed inspection and/or manipulation of the subset of microdroplets.

Typically, one of the optical assemblies has a smaller field of view than the other and therefore is capable of holding, inspecting and manipulating only a subset of the array. The optical assembly with the smaller field of view will be able to provide finer manipulation of droplets within the subset selected due to improved resolution of light sprites.

The step of temporarily forming the plurality of oEWOD traps may be carried out by an optical assembly and the step of temporarily forming a second array of oEWOD traps on the surface may be carried out by a second optical assembly.

The step of aligning one or more of the oEWOD traps of the second array with the oEWOD traps of the first array may enable a step of handing off the holding of the entire array of microdroplets between the first optical assembly and the second optical assembly.

Within this context, the phrase the entire array refers to all of the microdroplets that are currently being held, inspected and/or manipulated. These droplets may be in a uniform rectilinear array occupying the entire surface of the chip. However, as microdroplets are inspected, merged, demerged and otherwise manipulated, the array may cover only part of the chip. Furthermore, the droplets may not be in a rectilinear array, but may be patterned. Moreover, the phrase the entire array refers to all of the microdroplets in action at that time so that if a subset of the microdroplets are deselected and removed, then the remainder of the droplets are the entire array at that subsequent time.

Furthermore, according to one aspect of the present invention, there is provided a method of manipulating and inspecting microdroplets on a microfluidic chip by optically-mediated electrowetting (oEWOD), the method comprising: forming, using a first optical assembly, a plurality of oEWOD traps on a surface of the chip to cause a plurality of microdroplets on the surface of the chip to form an array of microdroplets corresponding to a first array of oEWOD traps; forming, using a second optical assembly, a second array of oEWOD traps on the surface of the chip, one or more of the oEWOD traps of the second array being aligned with the oEWOD traps of the first array; inspecting the contents of the array of microdroplets; and making an adjustment to the first optical assembly whilst one or more of the microdroplets are held in place by second array of oEWOD traps.

Having both first and second optical assemblies capable of forming arrays of oEWOD traps for holding and manipulating microdroplets on the surface of the chip greatly enhances the operational flexibility of the microfluidic chip as one of the optical assemblies may be used to keep either all or a selected portion of the microdroplets in place on the surface while the other assembly is either deactivated or adjusted, meaning that many thousands of droplets can be manipulated using different parameters or moved to different locations without droplets being lost during the interruptions necessitated by adjusting one of the assemblies.

In some embodiments, the method further comprises: selecting a subset of microdroplets from the array of microdroplets based on the inspection of the contents of the microdroplets; de-activating all oEWOD traps except for those trapping the selected subset of microdroplets; and performing a flush operation to remove the microdroplets not in the selected subset from the array of microdroplets.

The step of deactivating oEWOD traps for unselected microdroplets, such as those determined undesirable during a sorting operation, and performing a flush operation to remove the unwanted microdroplets can be performed at very large scales with little difficulty, such as in initial screening assays. For example, the inspection of the contents of the microdroplets may be an inspection to determine which microdroplets are empty and which contain cells to undergo further observation, and the unselected microdroplets to be flushed may be those which do not contain cells. In some embodiments, the flush operation comprises reordering the array of microdroplets using the oEWOD traps of the first optical assembly such that the removal of the microdroplets not in the subset is not impeded by the microdroplets which are in the subset, and/or admitting a continuous phase into the microfluidic chip via a plurality of fluid inlets to remove microdroplets not in the selected subset once the associated oEWOD traps have been de-activated.

An initial step in the flush operation of reordering the array to ensure that the removal of unwanted droplets is not impeded by droplets in the selected subset and in particular that unwanted microdroplets do not collide with droplets marked for further inspection during removal. Such a reordering may comprise, for example, switching unwanted microdroplets which are in the centre of the array with those selected for further inspection which are on the outer edges of the array. Furthermore, the use of a continuous phase to flush away unselected microdroplets further reduces the need for fine-grained control of the microdroplets in large scale operations as there is no need to manipulate the unselected droplets across the surface of the chip using the optical assemblies, but instead merely to maintain the positions of microdroplets in the selected subset by not deactivating the respective oEWOD traps. The continuous phase may consist of any of silicone oils, mineral oils and fluorocarbon oils.

In some embodiments, the adjustment to the first optical assembly comprises at least one of: a change in resolution, a change in magnification, a change in field of view, a change in a colour-selective element comprised in the assembly, and exchanging the lens assembly which is in closest proximity to the sample being imaged. In some embodiments, the method further comprises: using the first optical assembly to carry out a further inspection of the contents of the array of microdroplets after making the adjustment.

As described above, the methods of the present invention enable for greater operational flexibility in microdroplet assays, in particular for large scale microdroplet operations. In some embodiments, the methods of the present invention enable the parameters of an assay to be adjusted without losing any microdroplets from the initial array that is formed. For example, a first assay may be carried out using a first optical assembly with a wide field of view on an array comprising many thousands of microdroplets, a subset of those microdroplets may be selected for further inspection, then the second optical assembly may hold the selected microdroplets in place whilst the field of view of the first optical assembly is reduced to allow for more precise droplet manipulation or inspection. This example is not limiting, and the principle of adjusting the parameters of the first optical assembly in between successive assays whilst either a selected subset or all of the microdroplets in an array of microdroplets are held in place by the second optical assembly can be applied to increase efficiency and fine-tune microdroplet assays in various ways.

In some embodiments, the first optical assembly according to the present invention as disclosed herein can be used for moving, merging and/or splitting the microdroplets.

In some embodiments, the second optical assembly according to the present invention as disclosed herein can be used for manipulating microdroplets such as moving, merging and/or splitting the microdroplets on a microfluidic chip by optically-mediated electrowetting (oEWOD).

In some embodiments, the method further comprises deactivating the first optical assembly and using the oEWOD traps formed by the second optical assembly to translate the array of microdroplets across the surface of the microfluidic chip. Microfluidic chips often comprise a number of different zones which are designed for particular operations to be carried out within them. For example, a surface of a microdroplet may comprise a sorting zone, an inspection zone, or zones where the surface of the chip has been treated in order to be suitable for assays using particular types of cells. Another manner in which the operational flexibility of such assays can be improved by the use of a dual assembly configuration is where the same array of microdroplets or a selected subset thereof is transported by the second optical assembly between such zones before or after performing an assay. Translating an entire array of oEWOD traps using the second optical assembly has the advantage that no fine grained, droplet by droplet control of the oEWOD traps is required and that the relative positions of the droplets in the transported array are maintained with respect to each other.

In some embodiments, the first optical assembly has a higher imaging resolution than the second optical assembly. In the dual assembly configuration of the present invention, it can be advantageous to have one optical assembly designated as the creator of a “holding array” capable of holding and transporting a large number of microdroplets at once, and for the other optical assembly to be responsible for a high resolution, adjustable array suitable for implementing fine grained control of microdroplets in the array as and when is necessary.

In some embodiments, the step of forming the array of microdroplets comprises the initial steps of: forming a plurality of oEWOD traps using the second optical assembly in the shape of a target array; determining the locations of the plurality of microdroplets on the surface of the microfluidic chip using the first optical assembly; and using the plurality of oEWOD traps formed by the first assembly to manipulate the plurality of microdroplets into an array matching the target array of oEWOD traps. Whilst this operation requires precise droplet control, it is a reliable method of array formation for some chip configurations.

In other embodiments, the step of forming the array of microdroplets comprises: forming the first array of oEWOD traps using the first optical assembly; and loading the plurality of microdroplets onto the surface of the chip where the first array of oEWOD traps is located. Forming an array of oEWOD traps on the surface of the chip such that microdroplets located on the surface of the chip are caused to coalesce onto the oEWOD trap array positions is an efficient method of forming an array of microdroplets in assays which involve a great number of microdroplets to be analysed as it removes the need for precise droplet by droplet control during a loading phase. In this manner, arrays of many thousands of microdroplets can be formed quickly and easily.

In some embodiments, electromagnetic radiation from the first optical assembly is multiplexed with electromagnetic radiation from an inspection component configured to inspect the microdroplets and their contents. Combining the optical assembly for forming oEWOD traps with an inspection component allows for more efficient direction of the inspecting radiation.

In some embodiments, the inspection of the contents of the microdroplets is carried out using at least one of: fluorescent imaging, localized optical Plasmon resonance on metal nanoparticles, FRET, darkfield, brightfield, Raman, absorption, Quantum dot fluorescence, spectroscopy. Fluorescence based methods are particularly advantageous. In the case the interrogation metric is localized optical plasmon resonance on metal nanoparticles, the particles are functionalized with an antigen or an antibody, and the detection method detects changes in the spectral response of the functionalized nanoparticles in response to binding of a target molecule to the surface.

In some embodiments, at least one of the first and second arrays’ oEWOD traps are formed using projection optics consisting of at least one of: a spatial light modulator such as TFT, DMD projector, DLV, and a LCoS projector; a light-emitting array such as OLED, CRT, a projector with a screen, and a microLED array.

According to another aspect of the present invention, there is provided apparatus for manipulating microdroplets, comprising: a microfluidic chip comprising first and second composite walls defining a microfluidic space and configured to manipulate microdroplets on a surface defining the microfluidic space by optically-mediated electrowetting (oEWOD); a first optical assembly configured to form a first plurality of oEWOD traps to manipulate a plurality of microdroplets on the surface; a second optical assembly configured to form a second plurality of oEWOD traps on the surface to maintain the relative positions of the plurality of microdroplets during an adjustment to the first optical assembly and/or during a loading operation; and an inspection component configured to interrogate the contents of the plurality of microdroplets .

In some embodiments, the inspection component is a source of electromagnetic radiation and is multiplexed with electromagnetic radiation from the first optical assembly.

In some embodiments, the first and second composite walls are at least partially transparent and the first and second optical assemblies are located on opposing sides of the microfluidic space. In other embodiments, at least one of the first and second composite walls is transparent, the first and second optical assemblies are located on the same side of the microfluidic space, and wherein a chromatic filter is applied to the second optical assembly to prevent interference with the first optical assembly.

In some embodiments, at least one of the first and second optical assemblies comprises a microlens array. In some embodiments, the second optical assembly or both optical assemblies have relatively coarse-grained optical control; not necessarily switching every illumination spot independently but arranging them into small banks which can be separately actuated.

In some embodiments the apparatus further comprises sets of external flow control valves and pumps and an arrangement of inlets for the loading and flushing operations.

In some embodiments the optical assemblies are configured to provide a spot array with diameters between 20 µm and 250 µm, and are formed at a pitch of between 50 µm and 675 µm, in particular with diameters between 30 µm and 250 µm and a pitch of between 30 µm and 300 µm. The pitch is typically 2.5 times the drop diameter. In some embodiments the optical assemblies are configured to provide a spot array with an approximate pitch of 100 µm or 125 µm and a spot size of roughly 50 µm. In some embodiments the optical assemblies are configured to provide a spot array with diameters between 5 µm and 30 µm and are formed at a pitch of between 12.5 µm and 75 µm.

In some embodiments, the methods of the present invention are applied to an optically-activated device such as a device configured to manipulate microparticles, including microparticles in droplets, via dielectrophoresis. Cells or particles are manipulated and inspected using a functionally identical optical instrument to generate virtual optical dielectrophoresis gradients. Microparticles as defined herein may refer to particles such as biological cells, microbeads made of materials including polystyrene and latex, magnetic microbeads or colloids.

Similarly to the method described above for optical electrowetting, a first high-resolution optical assembly is used to perform fine manipulations and detailed inspection of the particles and/or cells through a combination of optically-mediated dielectrophoresis. A second coarse optical assembly is used to form an array of dielectrophoretic traps. The combination of these two assemblies gives the ability for the method to retain and transport a very large number of particles and/or cells using the coarse optical assembly, whilst performing fine manipulation and inspection operations using the fine optical assembly.

Thus according to another aspect of the present invention, apparatus is provided for manipulating micro-particles, the apparatus comprising: a chip comprising first and second transparent composite walls defining a holding space and configured to manipulate micro-particles located on a surface defining the holding space; a first optical assembly configured to direct an optical beam onto the surface via the first composite wall to form a first plurality of optical traps to manipulate a plurality of micro-particles on the surface; a second optical assembly configured to direct an optical beam onto the surface via the second composite wall to form a second plurality of optical traps on the surface to maintain the relative positions of the plurality of micro-particles during an adjustment to the first optical assembly and/or during a loading operation; and an inspection component configured to interrogate the contents of the plurality of micro-particles.

### FIGURES

FIG. 1 shows a cross sectional view of an example microfluidic chip as described in WO 2018/234445;

FIG. 2 shows a cross sectional view of an example microfluidic chip suitable for carrying out the methods of the present invention;

FIG. 3 shows a top down view of the surface of the microfluidic space;

FIGS. 4A to 4E show examples of a process of a loading operation and droplet interrogation workflow;

FIGS. 5A and 5B provide an illustration of a merging operation with droplets according to the present invention;

FIGS. 5C and 5D provide an illustration of a splitting operation of droplets according to the present invention;

FIGS. 6A and 6B provide an alternative illustration of a merging operation with droplets according to the present invention; and

FIGS. 6C and 6D provide an alternative illustration of a splitting operation of droplets according to the present invention.

### DETAILED DESCRIPTION OF EMBODIMENTS

In order to further explain various aspects of the present disclosure, specific embodiments of the present disclosure will now be described in detail in conjunction with the accompanying drawings.

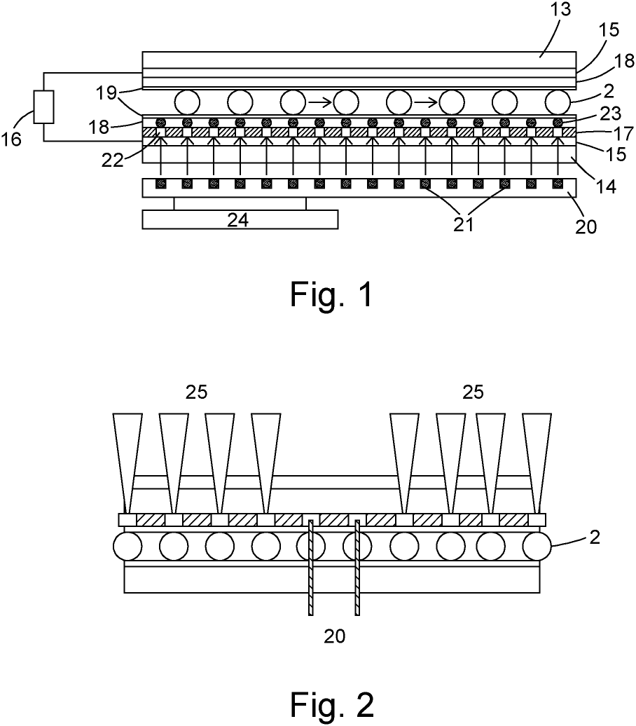

Referring to FIG. 1, a cross-sectional view of an example microfluidic chip device comprising an oEWOD structure suitable for the fast manipulation of aqueous microdroplets is shown, as described in WO 2018/234445.

The device comprises top 13 and bottom glass plates and 14 each 500 µm thick coated with transparent layers of conductive Indium Tin Oxide (ITO) 15 having a thickness of 130 nm. Each of the ITO layers 15 is connected to an A/C source 16 with the ITO layer on the bottom glass plate 14 being the ground. Bottom glass plate 14 is coated with a layer of amorphous silicon 17 which is 800 nm thick. Top glass plate 13 and the layer of amorphous silicon 17 are each coated with a 160 nm thick layer of high purity alumina or Hafnia 18 which are in turn coated with an interstitial layer of silicon dioxide supporting a layer of Trichloro(1H,1H,2H,2H-perfluorooctyl)silane 19 to render the surfaces of the alumina/Hafnia layer 18 hydrophobic. Top glass plate 13 and the layer of amorphous silicon 17 are spaced 80 µm apart using spacers so that the microdroplets undergo a degree of compression when introduced into the device.

An image of a reflective pixelated screen, illuminated by a first optical assembly, in this example an LED light source, 20 is disposed generally beneath bottom glass plate 14 and visible light (wavelength 660 or 830 nm) at a level of 0.01 Wcm-2 is emitted from each diode 21 and caused to impinge on the layer of amorphous silicon 17 by propagation in the direction of the multiple upward arrows through the bottom layers 14 and 15. At the various points of impingement, photoexcited regions of charge 22 are created in the layer of amorphous silicon 17 which induce modified liquid-solid contact angles in the alumina/Hafnia layer 18 at corresponding electrowetting locations 23 to create oEWOD traps at those locations. The modified properties of the oEWOD trap locations provide the capillary force necessary to either hold the microdroplets 2 in place or to propel the microdroplets 2 from one point 23 to another. The optical assembly 20 is controlled by a microprocessor 24 which determines which of the diodes 21 in the array are illuminated at any given time by pre-programmed algorithms.

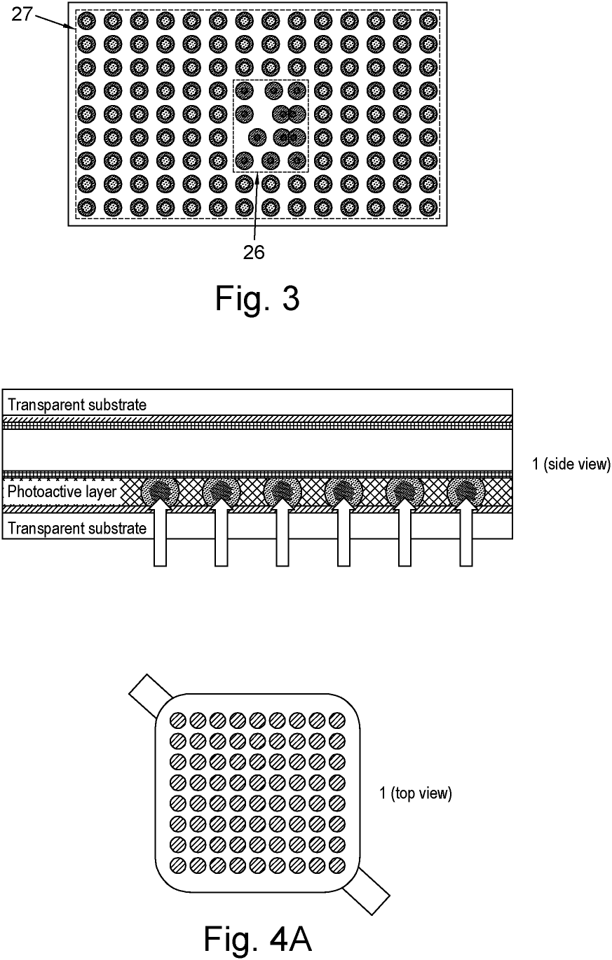

Referring to FIG. 2, a cross-sectional view of a microfluidic chip having the same or similar stack structure to the chip of FIG. 1 is illustrated, wherein additional to the first optical assembly 20, a second, separately controllable optical assembly 25 has been introduced to provide increased flexibility and capacity for operations involving the processing of large numbers of microdroplets 2.

The light source from the second optical assembly can be activated and aligned to the positions of the microdroplets held by the first light source during a loading option, and/or can act as a holding light source during an adjustment of the first optical assembly, such as for example during switching of a lens in the first light source, during interrogation, or during translation of a microdroplet array across a surface of the microfluidic space.

The light sources of the optical assemblies need not always be LED light sources. Any optical arrangement which can be used to project an array of programmable light spots in the photoactive layer would be suitable. For example, the projection optics could consist of an LED or LCD screen combined with a microlens array arrangement or a Fly’s Eye arrangement. In the examples of the present disclosure, the optoelectrowetting illumination pattern is spatially modulated across object plane, that is, the plane of the surface on which the oEWOD traps are formed, using for example a digital micromirror device, an LCD display, a spatial light modulator or an LED array. An example projected spot array could consist of spots with diameter 50um at a pitch, that is, centre-to-centre distance between spots, of 100um.

In some examples the apparatus of FIG. 2 comprises a combined inspection and manipulation optical assembly in which light suitable for the optoelectrowetting manipulations is multiplexed with light suitable for fluorescence excitation. Alternatively the inspection and manipulation components may be physically separate, for example if the interrogation component is not a source of electromagnetic radiation but a passive collection system.

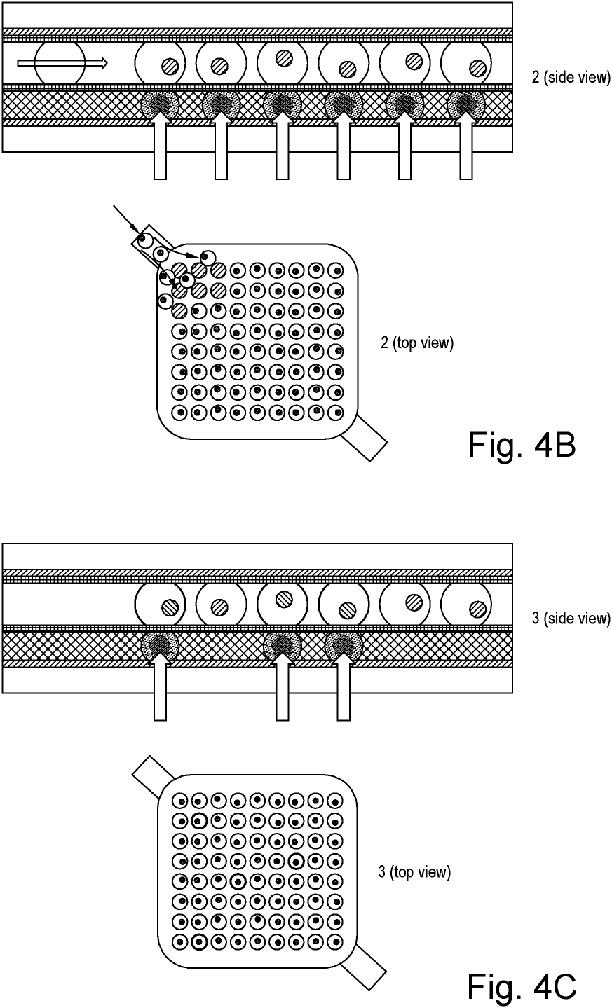

Referring to FIG. 3, a top down view of the surface of the microfluidic space having been loaded with a large number of microdroplets is illustrated. In this example, the field of view of the first optical assembly 20, i.e. the area of influence exerted over the microdroplets 2 on the surface, is shown by a first boundary 26, and the field of view of the second optical assembly 25 is shown by a second boundary 27. In the example configuration of FIG. 3, it can be seen that the first optical assembly has a much narrower field of view and is therefore more suitable for the fine manipulation of a smaller number of microdroplets, whereas the second optical assembly has a much wider field of view suitable for maintaining a large number of microdroplets in place across the majority of the surface.

Typically, the inspection component has an objective lens with a high numerical aperture suitable for maximising the light collection efficiency and the resolution of the fluorescence imaging. By switching this objective lens it is possible to increase or decrease the imaging magnification and concomitantly increase or decrease the resolution and collection efficiency during assays inspecting the contents of microdroplets in the chip. Increasing the magnification can necessitate a reduction of the field of view of the imaging system.

In the case where the inspection optical train and the opto-electrowetting manipulation optical train are multiplexed, a reduction in the field of view will lead to droplets which were held in position by the manipulation pattern becoming outside the field of view of the optics; during this time they can move away through diffusion or fluid flow.

Similarly, the process of exchanging the objective lens leads to a temporary interruption of the manipulation pattern, during which droplets may flow away and be lost. Additionally, in some cases it may be necessary to interrupt the optical manipulation light during fluorescence imaging in order to prevent light from the manipulation pattern interfering with the fluorescence image; during this prolonged interruption there is again potential for droplets to move in an uncontrolled fashion.

By combining a low-resolution spot generation optical assembly with the high resolution inspection and manipulation assembly it is possible to overcome these limitations.

In an example process, droplets are positioned to a particular layout in the microfluidic chip using the high resolution optical assembly and then imaged. A pattern is then generated on the low-resolution spot generation assembly which aligns to the droplet positions. This pattern from the low resolution assembly can then be activated as a holding pattern when the objective lens of the inspection assembly is exchanged; it can also be used to hold droplets which end up outside the field of view and it can be used to hold droplets during fluorescence acquisition. Alternatively, in some embodiments, the droplets may be positioned to a particular layout by the low resolution optical assembly and inspected by the high resolution optical assembly.

The process may be controlled by software generating pixel maps on the target surface from both illumination sources to create a 2D co-ordinate transform between the two sources which then is applied to the high-resolution source. The co-ordinate transform accounts for pixel scaling and displacement between the two projectors as well as range of different objective lenses for the high-resolution source.

If a broadband light source is chosen for the low resolution optical assembly it is possible to eliminate interference with the light used for fluorescence imaging by applying a blocking ‘notch’ filter to the input light which removes a band of the spectrum whilst allowing light outside that band to be used for the holding pattern.

Furthermore the low resolution optical assembly can be used as a holding mechanism for retaining the relative position between droplets when the sample is moved. For example, if it is necessary to translate the sample using a mechanical motorised motion stage, it is possible to shift the pattern registration such that the droplets move in near-unison with the stage in a stepwise fashion such that their relative positions remain unchanged.

In order to make the two optoelectrowetting control patterns (from the high-resolution and low-resolutions assemblies) overlap it is preferable to use an optoelectrowetting device that is substantially transparent, so that one pattern can be projected from each side of the device. Alternatively, the low-resolution pattern can be applied from the same side as the high-resolution pattern but at an oblique angle such that the light enters outside the numerical aperture of the objective lens of the high resolution assembly. In this case it is preferable to add compensatory optical elements to the low-resolution projector to adjust the shape and focus of the projection pattern to avoid image distortions caused by projection at an oblique angle.

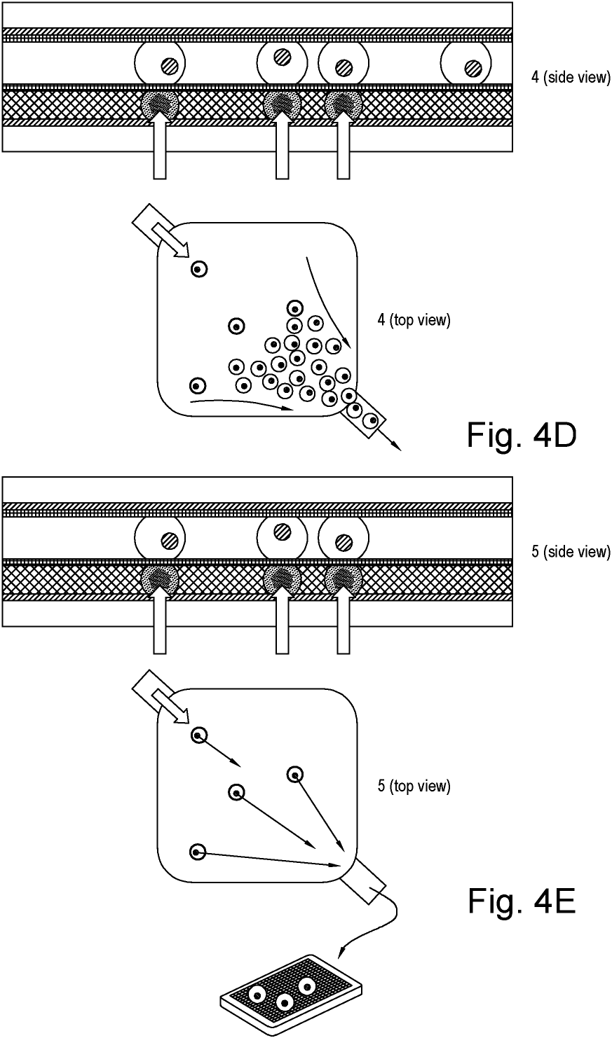

Referring to FIGS. 4A to 4E, another example process of a loading operation and droplet interrogation workflow which is suitable for processing a large number of microdroplets, for example over a million, without the requirement for precise droplet-by-droplet control, is illustrated.

Referring to FIG. 4A, in a first step, the light spots projected by an optical assembly in the shape of an array cause photoexcitation of the photoactive layer resulting in a charge build-up on the surface of the dielectric layer which acts as optical traps (oEWOD traps) for microdroplets on the surface of the microfluidic space within the microfluidic chip.

Referring to FIG. 4B, in a second step, dropletised biological agents such as cells are introduced into the device under flow in a continuous phase which could consist of oils such as silicone oils, minerals oil or fluorocarbon oils. The interaction between the microdroplets containing the biological agents and the optical traps causes the microdroplets to self-arrange and coalesce into a pattern matching the array pattern of the projection optics (optical assembly).

Referring to FIG. 4C, the array of trapped microdroplets are then interrogated through the transparent substrate of the microfluidic chip, with the results of the interrogation being used to select a subset of the droplets based on a predetermined metric. This metric could be, for example, fluorescence imaging or Surface Plasmon Resonance detection on metal nanoparticles.

Referring to FIG. 4D, once the subset of microdroplets have been selected, the light spots corresponding to the unwanted microdroplets which are not in the selected subset are turned off and the corresponding microdroplets are removed from the interrogation zone of the surface of the chip, optionally being removed from the microfluidic chip entirely, under a continuous flow which is introduced to the microfluidic chip for that purpose via a series of pumps and valves.

Referring to FIG. 4E, the set of selected microdroplets are then moved under flow off the chip for further post-processing or analysis or kept on the chip for further processing and analysis using the previously described arrangement of using a micro-mirror array to control the light spots and droplet motion.

Further to the specific example provided and illustrated by FIG. 1, general properties and optional features of oEWOD microfluidic chips suitable for carrying out the methods of the present invention and the composite structures comprised therein will now be described.

The oEWOD structures are comprised of: a first composite wall comprised of a first substrate a first transparent conductor layer on the substrate, the first transparent conductor layer having a thickness in the range 70 to 250 nm; a photoactive layer activated by electromagnetic radiation in the wavelength range 400-850 nm on the conductor layer, the photoactive layer having a thickness in the range 300-1500 nm and a first dielectric layer on the photoactive layer, the first dielectric layer having a thickness in the range 30 to 160 nm; a second composite wall comprised of: a second substrate; a second conductor layer on the substrate, the second conductor layer having a thickness in the range 70 to 250 nm and optionally a second dielectric layer on the second conductor layer, the second dielectric layer having a thickness in the range 30 to 160 nm wherein the exposed surfaces of the first and second dielectric layers are disposed 20-180 µm apart to define a microfluidic space adapted to contain microdroplets; an A/C source to provide a voltage across the first and second composite walls connecting the first and second conductor layers; first and second sources of electromagnetic radiation having an energy higher than the bandgap of the photoactive layer adapted to impinge on the photoactive layer to induce corresponding virtual electrowetting locations on the surface of the first dielectric layer; and means for manipulating the points of impingement of the electromagnetic radiation on the photoactive layer so as to vary the disposition of the virtual electrowetting locations thereby creating at least one electrowetting pathway along which the microdroplets may be caused to move. The first and second walls of these structures are transparent with the microfluidic space sandwiched in-between.

Suitably, the first and second substrates are made of a material which is mechanically strong for example glass metal or an engineering plastic. In some embodiments, the substrates may have a degree of flexibility. In yet another embodiment, the first and second substrates have a thickness in the range 100-1000 µm. In some embodiments the first substrate is comprised of one of Silicon, fused silica, and glass. In some embodiments, the second substrate is comprised of one of fused silica and glass.

The first and second conductor layers are located on one surface of the first and second substrates and typically have a thickness in the range 70 to 250 nm, preferably 70 to 150 nm. At least one of these layers is made of a transparent conductive material such as Indium Tin Oxide (ITO), a very thin film of conductive metal such as silver or a conducting polymer such as PEDOT or the like. These layers may be formed as a continuous sheet or a series of discrete structures such as wires. Alternatively, the conductor layer may be a mesh of conductive material with the electromagnetic radiation being directed between the interstices of the mesh.

The photoactive layer is suitably comprised of a semiconductor material which can generate localised areas of charge in response to stimulation by the source of the second electromagnetic radiation. Examples include hydrogenated amorphous silicon layers having a thickness in the range 300 to 1500 nm. In some embodiments, the photoactive layer is activated by the use of visible light. The photoactive layer in the case of the first wall and optionally the conducting layer in the case of the second wall are coated with a dielectric layer which is typically in the thickness range from 30 to 160 nm. The dielectric properties of this layer preferably include a high dielectric strength of >10^7 V/m and a dielectric constant of >3. Preferably, it is as thin as possible consistent with avoiding dielectric breakdown. In some embodiments, the dielectric layer is selected from alumina, silica, hafnia or a thin non-conducting polymer film.

In another embodiment of these structures, at least the first dielectric layer, preferably both, are coated with an anti-fouling layer to assist in the establishing the desired microdroplet/carrier fluid/surface contact angle at the various virtual electrowetting electrode locations, and additionally to prevent the contents of the microdroplets adhering to the surface and being diminished as the microdroplet is moved through the chip. If the second wall does not comprise a second dielectric layer, then the second anti-fouling layer may be applied directly onto the second conductor layer.

For optimum performance, the anti-fouling layer should assist in establishing a microdroplet/carrier fluid/surface contact angle that should be in the range 50-180 when measured as an air-liquid-surface three-point interface at 250C. In some embodiments, these layer(s) have a thickness of less than 10 nm and are typically a monomolecular layer. In another, these layers are comprised of a polymer of an acrylate ester such as methyl methacrylate or a derivative thereof substituted with hydrophilic groups; e.g. alkoxysilyl. Either or both of the anti-fouling layers are hydrophobic to ensure optimum performance. In some embodiments an interstitial layer of silica of thickness less than 20 nm may be interposed between the anti-fouling coating and the dielectric layer in order to provide a chemically compatible bridge.

The first and second dielectric layers, and therefore the first and second walls, define a microfluidic space which is at least 10 µm, and preferably in the range of 20-180 µm, in width and in which the microdroplets are contained. Preferably, before they are contained, the microdroplets themselves have an intrinsic diameter which is more than 10% greater, suitably more than 20% greater, than the width of the microdroplet space. Thus, on entering the chip the microdroplets are caused to undergo compression leading to enhanced electrowetting performance through e.g. a better microdroplet merging capability. In some embodiments the first and second dielectric layers are coated with a hydrophobic coating such a fluorosilane.

In another embodiment, the microfluidic space includes one or more spacers for holding the first and second walls apart by a predetermined amount. Options for spacers include beads or pillars, ridges created from an intermediate resist layer which has been produced by photo-patterning. Alternatively, deposited material such as silicon oxide or silicon nitride may be used to create the spacers. Alternatively layers of film, including flexible plastic films with or without an adhesive coating, can be used to form a spacer layer. Various spacer geometries can be used to form narrow channels, tapered channels or partially enclosed channels which are defined by lines of pillars. By careful design, it is possible to use these spacers to aid in the deformation of the microdroplets, subsequently perform microdroplet splitting and effect operations on the deformed microdroplets. Similarly these spacers can be used to physically separate zones of the chip to prevent cross-contamination between droplet populations, and to promote the flow of droplets in the correct direction when loading the chip under hydraulic pressure.

The first and second walls are biased using a source of A/C power attached to the conductor layers to provide a voltage potential difference therebetween; suitably in the range 10 to 50 volts. These oEWOD structures are typically employed in association with a source of second electromagnetic radiation having a wavelength in the range 400-850 nm, preferably 660 nm, and an energy that exceeds the bandgap of the photoactive layer. Suitably, the photoactive layer will be activated at the virtual electrowetting electrode locations where the incident intensity of the radiation employed is in the range 0.01 to 0.2 Wcm-2.

Where the sources of electromagnetic radiation are pixelated they are suitably supplied either directly or indirectly using a reflective screen such as a digital micromirror device (DMD) illuminated by light from LEDs or other lamps. This enables highly complex patterns of virtual electrowetting electrode locations to be rapidly created and destroyed on the first dielectric layer thereby enabling the microdroplets to be precisely steered along essentially any virtual pathway using closely-controlled electrowetting forces. Such electrowetting pathways can be viewed as being constructed from a continuum of virtual electrowetting electrode locations on the first dielectric layer.

The points of impingement of the sources of electromagnetic radiation on the photoactive layer can be any convenient shape including the conventional circular or annular. In some embodiments, the morphologies of these points are determined by the morphologies of the corresponding pixilation and in another correspond wholly or partially to the morphologies of the microdroplets once they have entered the microfluidic space. In one embodiment, the points of impingement and hence the electrowetting electrode locations may be crescent-shaped and orientated in the intended direction of travel of the microdroplet. Suitably the electrowetting electrode locations themselves are smaller than the microdroplet surface adhering to the first wall and give a maximal field intensity gradient across the contact line formed between the droplet and the surface dielectric.

In some embodiments of the oEWOD structure, the second wall also includes a photoactive layer which enables virtual electrowetting electrode locations to also be induced on the second dielectric layer by means of the same or different source of electromagnetic radiation. The addition of a second dielectric layer enables transition of the wetting edge of a microdroplet from the upper to the lower surface of the structure, and the application of more electrowetting force to each microdroplet.

The first and the second dielectric layers may be composed of a single dielectric material or it may be a composite of two or more dielectric materials. The dielectric layers may be made from, but is not limited to, Al₂O₃ and SiO₂.

A structure may be provided between the first and second dielectric layers. The structure between the first and second dielectric layers can be made of, but is not limited to, epoxy, polymer, silicon or glass, or mixtures or composites thereof, with straight, angled, curved or micro-structured walls/faces. The structure between the first and second dielectric layers may be connected to the top and bottom composite walls to create a sealed microfluidic device and define the channels and regions within the device. The structure may occupy the gap between the two composite walls. Alternatively, or additionally, the conductor and dielectrics may be deposited on a shaped substrate which already has walls.

Some aspects of the methods and apparatus of the present invention are suitable to be applied to an optically-activated device other than an electrowetting device, such as a device configured to manipulate microparticles via dielectrophoresis or optical tweezers. In such a device cells or particles are manipulated and inspected using a functionally identical optical instrument to generate virtual optical dielectrophoresis gradients. Microparticles as defined herein may refer to particles such as biological cells, microbeads made of materials including polystyrene and latex, hydrogels, magnetic microbeads or colloids. Dielectrophoresis and optical tweezer mechanisms are well known in the art and could be readily implemented by the skilled person.

Similarly to the method described above for optical electrowetting, a first high-resolution optical assembly is used to perform fine manipulations and detailed inspection of the particles and/or cells through a combination of optically-mediated dielectrophoresis. A second coarse optical assembly is used to form an array of dielectrophoretic traps. The combination of these two assemblies gives the ability for the method to retain and transport a very large number of particles and/or cells using the coarse optical assembly, whilst performing fine manipulation and inspection operations using the fine optical assembly.

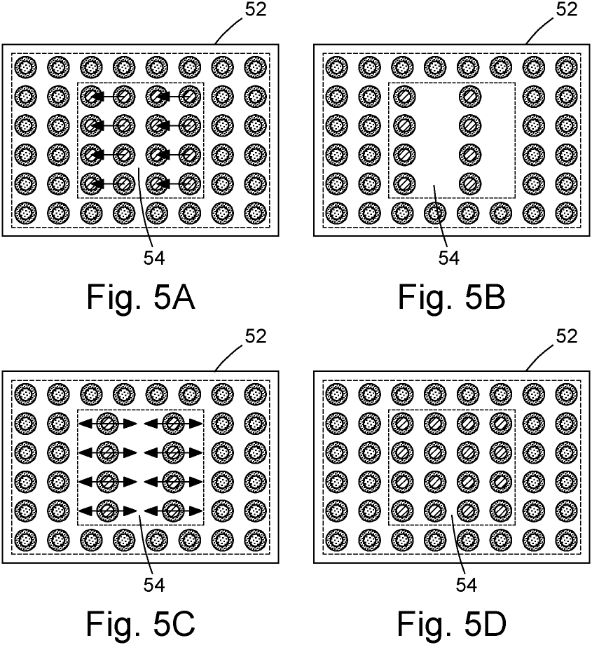

Referring to FIGS. 5A and 5B, there is provided an illustration of a merging operation with droplets held within a large area 52 using the second optical setup, as described herein, and merged within a smaller field of view 54 using the first optical set up, as disclosed herein. FIG. 5A shows the droplets prior to merging. The arrows as indicated in FIG. 5A illustrates a direction in which droplets are merged together. FIG. 5B shows the merged droplet after the merging operation.

Referring to FIGS. 5C and 5D, there is provided an illustration of a splitting operation with droplets held within a large area 52 using the second optical set up, as described herein, and split within a smaller field of view 54 using the first optical set up, as described herein. The arrows as indicated in FIG. 5C illustrate a splitting direction for the droplets to provide further droplets. FIG. 5D shows the post splitting event after the splitting operation.

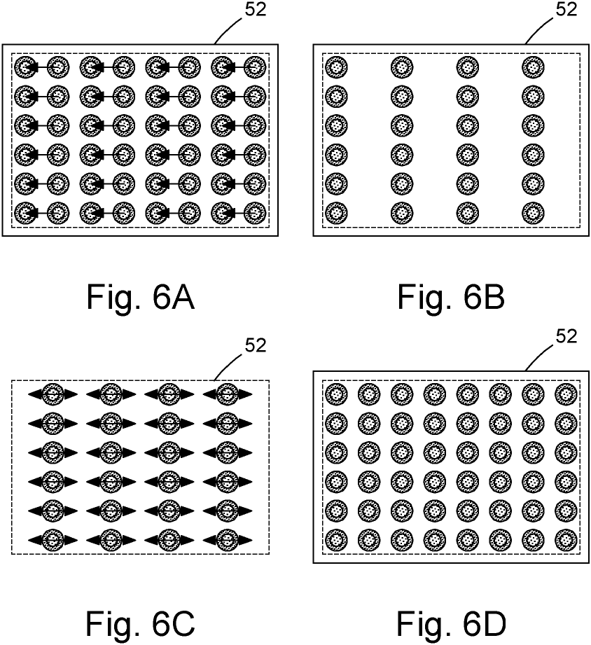

Referring to FIGS. 6A and 6B, there is provided an illustration of a merging operation in which droplets held between operations by the second optical setup 52 and merged during operations using the second optical setup 52, as disclosed herein. The arrows indicated in FIG. 6A illustrate the direction of droplets during the merging operation. FIG. 6B shows the merged droplet after the merging operation.

Referring to FIGS. 6C and 6D, there is provided an illustration of a spliting operation of droplets held between operations by the second optical set up 52 and the droplets are split during the splitting operation using the second optical set up. The arrows indicated in FIG. 6C illustrate the direction of droplets splitting during the splitting operation to form further droplets. FIG. 6D shows a plurality of droplets formed after the splitting operation.

The optical assembly that inspects the subset of the array has a considerably smaller field of view than the optical assembly holding the array in place. Within the reduced field of view, there may be just one microdroplet. Alternatively, there may be 24, 48, 256, 1048 or any suitable number of microdroplets in the field of view of the inspecting optical assembly. The inspection may take place on a microdroplet by microdroplet basis, with the optical assembly scanning through its field of view to inspect each microdroplet sequentially. This can involve the optics being in a single location and the scanning referring to an inspection of a part of the FOV by processing information from part of the image falling on an imaging sensor such as a camera forming part of the optical assembly. Alternatively, or additionally, the optical assembly may integrate across its entire field of view to take an overview of the proportion of the microdroplets emitting. This coarse grain data may be combined with microdroplet by microdroplet review in order to focus quickly onto the most information rich parts of the array.

Various further aspects and embodiments of the present invention will be apparent to those skilled in the art in view of the present disclosure. “and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

It will further be appreciated by those skilled in the art that although the invention has been described by way of example with reference to several embodiments, it is not limited to the disclosed embodiments and that alternative embodiments could be constructed without departing from the scope of the invention as defined in the appended claims.

1. A method of inspecting and/or selecting microdroplets on a microfluidic chip by optically-mediated electrowetting (oEWOD), the method comprising:
temporarily forming a plurality of oEWOD traps on a surface of the chip to cause a plurality of microdroplets on the surface of the chip to form an array of microdroplets;
holding the entire array of microdroplets whilst inspecting at least one subset of the array.

2. The method according to claim 1, wherein the step of holding the entire array of microdroplets is facilitated by the substeps of:
temporarily forming a second array of oEWOD traps on the surface of the chip; and
aligning one or more of the oEWOD traps of the second array with the oEWOD traps of the first array.

3. The method according to claim 1, wherein the step of temporarily forming the plurality of oEWOD traps is carried out by an optical assembly and the step of temporarily forming a second array of oEWOD traps on the surface is carried out by a second optical assembly.

4. The method according to claim 2, wherein the step of aligning one or more of the oEWOD traps of the second array with the oEWOD traps of the first array enables a step of handing off the holding of the entire array of microdroplets between the first optical assembly and the second optical assembly.

5. The method according to claim 1, the method further comprising:
making an adjustment to the first optical assembly whilst one or more of the microdroplets are held in place by second array of oEWOD traps.

6. The method of claim 1, wherein the method further comprises manipulation of the microdroplets in the following steps:
selecting a subset of microdroplets from the array of microdroplets based on the inspection of the contents of the microdroplets;
de-activating all oEWOD traps except for those trapping the selected subset of microdroplets; and
performing a flush operation to remove the microdroplets not in the selected subset from the array of microdroplets.

7. The method of claim 6, wherein the flush operation comprises:
reordering the array of microdroplets using the oEWOD traps of the first optical assembly or the second optical assembly such that the removal of the microdroplets not in the subset is not impeded by the microdroplets which are in the subset, and/or
admitting a continuous phase into the microfluidic chip via a plurality of fluid inlets to remove microdroplets not in the selected subset once the associated oEWOD traps have been deactivated.

8. The method of claim 5, wherein the adjustment to the first optical assembly comprises at least one of: a change in resolution, a change in magnification, a change in field of view, a change to illumination source, a change in a colour-selective element comprised in the assembly, and exchanging a lens assembly which is in closest proximity to the sample being imaged.

9. The method of claim 5, wherein the method further comprises: using the first optical assembly to carry out a further inspection of the contents of the array of microdroplets after making the adjustment.

10. The method of claim 3, wherein the method further comprises: deactivating the first optical assembly and using the oEWOD traps formed by the second optical assembly to translate the array of microdroplets across the surface of the microfluidic chip.

11. The method of claim 3, wherein the step of forming the array of microdroplets comprises the initial steps of:
forming a plurality of oEWOD traps using the second optical assembly in the shape of a target array;
determining the locations of the plurality of microdroplets on the surface of the microfluidic chip using the first optical assembly;
using the plurality of oEWOD traps formed by the first assembly to manipulate the plurality of microdroplets into an array matching the target array of oEWOD traps.

12. The method of claim 3, wherein the step of forming the array of microdroplets comprises:
forming the first array of oEWOD traps using the first optical assembly; and
loading the plurality of microdroplets onto the surface of the chip where the first array of oEWOD traps is located.

13. The method of claim 1, wherein the inspection of the contents of the microdroplets is carried out using at least one of: fluorescent imaging, localized optical plasmon resonance on metal nanoparticles, FRET, darkfield, brightfield, Raman, absorption, Quantum dot fluorescence, spectroscopy.

14. Apparatus for manipulating microdroplets, comprising:
a microfluidic chip comprising first and second composite walls defining a microfluidic space and configured to manipulate microdroplets on a surface defining the microfluidic space by optically-mediated electrowetting (oEWOD);
a first optical assembly configured to form a first plurality of oEWOD traps to manipulate a plurality of microdroplets on the surface;
a second optical assembly configured to form a second plurality of oEWOD traps on the surface to maintain the relative positions of the plurality of microdroplets during an adjustment to the first optical assembly and/or during a loading operation; and
an inspection component configured to interrogate the contents of the plurality of microdroplets.

15. The apparatus of claim 14, wherein inspection component is a source of electromagnetic radiation and is multiplexed with electromagnetic radiation from the first optical assembly.

16. The apparatus of claim 14, wherein the first and second composite walls are at least partially transparent and the first and second optical assemblies are located on opposing sides of the microfluidic space.

17. The apparatus of claim 14, wherein at least one of the first and second composite walls is transparent, the first and second optical assemblies are located on the same side of the microfluidic space, and wherein a chromatic filter is applied to the second optical assembly to prevent interference with the first optical assembly.

18. The apparatus of claim 14, wherein at least one of the first and second optical assemblies comprises a microlens array.

19. Apparatus for manipulating micro-particles, the apparatus comprising:
a chip comprising first and second transparent composite walls defining a holding space and configured to manipulate micro-particles located on a surface defining the holding space;
a first optical assembly configured to direct an optical beam onto the surface via the first composite wall to form a first plurality of optical traps to manipulate a plurality of micro-particles on the surface;
a second optical assembly configured to direct an optical beam onto the surface via the second composite wall to form a second plurality of optical traps on the surface to maintain the relative positions of the plurality of micro-particles during an adjustment to the first optical assembly and/or during a loading operation; and
an inspection component configured to interrogate the contents of the plurality of micro-particles.

20. The method of claim 14, wherein the first or second optical assembly includes projection optics comprising at least one of: a spatial light modulator such as TFT, DMD projector, DLV, and a LCoS projector; a light-emitting array such as OLED, CRT, a projector with a screen, and a microLED array.
